(19) United States
(12) Patent Application Publication
(10) Pub. No.: US 2012/0249795 A1
(43) Pub. Date: Oct. 4, 2012

(54) SIGNAL RECOGNIZING DEVICE, SIGNAL RECOGNIZING METHOD AND SIGNAL RECOGNIZING PROGRAM

(75) Inventor: Kohei Ito, Kawagoe (JP)

(73) Assignee: PIONEER CORPORATION, Kanagawa (JP)

(21) Appl. No.: 13/515,414

(22) PCT Filed: Dec. 16, 2009
(86) PCT No.: PCT/JP2009/070976

§ 371 Date: Jun. 18, 2012

(51) Int. Cl. H04N 7/18

(52) U.S. Cl. 348/148; 348/E07.085

(57) ABSTRACT

A signal recognizing device is mounted on a moving body, and connects to a camera. The signal recognizing device includes a storage unit, a signal display candidate detecting unit (SDCDU), a reference calculating unit (RCU) and a green lighting determination unit (GLDU). The SDCDU detects red lamp candidate areas from an image. The RCU calculates a moving average of pixel value per pixel existing in the green lamp candidate area, and stores the moving averages. For each pixel value of the green lamp candidate area, the RCU omits the pixel value from the samples for calculating the moving average if a difference between the pixel value and the moving average exceeds a threshold. Upon red lamp transition to an unlit state, it determines whether a green lamp is lit based on the image captured at the time of the unlit state of the red lamp and the moving averages.

### TECHNICAL FIELD

The present invention relates to a signal recognizing technology of recognizing a display of a traffic signal.

### BACKGROUND TECHNIQUE

Conventionally, there is proposed a technique of recognizing a traffic signal by using the time variation of the colors in the lamps of the traffic signal. For example, Patent Reference-1 discloses a technique which considers the traffic signal lamps, which are not determined to be lit, to be unlit, and which recognizes the lit state of the lamp by comparing the brightness detected at the unlit state to the present brightness. Patent Reference-2 discloses a technique of extracting a candidate area of the signal lamp on the basis of the color and the degree of the circularity. Furthermore, Patent Reference-2 also discloses a technique of determining whether or not it happens that a candidate area of the red lamp vanishes and that a new candidate area of the red lamp arises by comparing the previous frame to the present frame in order to detect a lit state of the green lamp.

Patent Reference-1: Japanese Patent Application Laid-open under No. 2000-353292

Patent Reference-2: Japanese Patent Application Laid-open under No. 2005-301519

### DISCLOSURE OF INVENTION

### Problem to be Solved by the Invention

As described above, by detecting the variation of the candidate area of the red lamp from vanishing to arising by comparing the previous frame to the present frame, it is possible to detect a lit state of the green lamp. In contrast, when a state of a simultaneous lighting (hereinafter referred to as “red-green simultaneous lighting”) of the red lamp and the green lamp is displayed in the image due to the exposure time of the camera, it occurs that the difference of the brightness of the candidate area of the green lamp between the previous frame and the present frame becomes small. Thus, in this case, the signal recognizing device cannot properly recognize the lit state of the green lamp. In a case where the traffic signal is temporarily obscured by a tall vehicle such as a truck, a similar problem as the above-mentioned red-green simultaneous lighting arises. In Patent Reference-1 and Patent Reference-2, the above problem is not disclosed at all.

The above is an example of the problem to be solved by the present invention. An object of the present invention is to provide a signal recognizing device which precisely recognizes the display of a traffic signal even in the case where the red-green simultaneous lighting or the obstruction occurs.

### Means for Solving the Problem

The invention according to claim 1 is a signal recognizing device which is mounted on a moving body and which electromagnetically connects to a camera, comprising: a signal display candidate detecting unit which detects a green lamp candidate area from an image obtained from the camera; a reference calculating unit which calculates a time-series statistic of unit area values per unit area of the green lamp candidate area in a state where a red lamp is lit, and which stores the statistics on a storage unit; and a green lighting determination unit which determines whether or not a green lamp is lit based on the image including the green lamp candidate area in a state where the red lamp is unlit and the statistics, in case of determining that the red lamp varies from a lit state to an unlit state; wherein the reference calculating unit omits unit area values of unit areas of the green lamp candidate area from samples for calculating the statistics, provided that between the unit area values and either the statistics or unit area values of unit areas of a green lamp candidate area existing in a previously obtained image are larger than a predetermined threshold.

The invention according to claim 8 is a signal recognizing method executed by a signal recognizing device which is mounted on a moving body and which electromagnetically connects to a camera, comprising: a signal display candidate detecting process which detects a green lamp candidate area from an image obtained from the camera; a reference calculating process which calculates a time-series statistic of unit area values per unit area of the green lamp candidate area in a state where a red lamp is lit, and which stores the statistics on a storage unit; and a green lighting determination process which determines whether or not a green lamp is lit based on the image including the green lamp candidate area in a state where the red lamp is unlit and the statistics, in case of determining that the red lamp varies from a lit state to an unlit state; wherein the reference calculating process omits unit area values of unit areas of the green lamp candidate area from samples for calculating the statistics, provided that between the unit area values and either the statistics or unit area values of unit areas of a green lamp candidate area existing in a previously obtained image are larger than a predetermined threshold.

The invention according to claim 9 is a signal recognizing program executed by a signal recognizing device which is mounted on a moving body and which electromagnetically connects to a camera, making the signal recognizing device function as: a signal display candidate detecting unit which detects a green lamp candidate area from an image obtained from the camera; a reference calculating unit which calculates a time-series statistic of unit area values per unit area of the green lamp candidate area in a state where a red lamp is lit, and which stores the statistics on a storage unit; and a green lighting determination unit which determines whether or not a green lamp is lit based on the image including the green lamp candidate area in a state where the red lamp is unlit and the statistics, in case of determining that the red lamp varies from a lit state to an unlit state; wherein the reference calculating unit omits unit area values of unit areas of the green lamp candidate area from samples for calculating the statistics, provided that between the unit area values and either the statistics or unit area values of unit areas of a green lamp candidate area existing in a previously obtained image are larger than a predetermined threshold.

### BRIEF DESCRIPTION OF THE DRAWINGS

FIG. 1 is one example of a schematic configuration of the signal recognizing device.

FIG. 2 is one example of the functional block of the signal recognizing device.

FIGS. 3A and 3B show images each including the traffic signal and enlarged green lamp candidate area Lb.

FIGS. 4A and 4B show the image captured in the case where the obstruction occurs and an outline of the process executed by the reference calculating unit 202.

FIG. 5 shows an outline of the process executed by the green lighting determination unit 203.

FIG. 6 is one example of a flowchart showing a procedure of the process according to the embodiment.

FIG. 7 is an outline of the process executed by the green lighting determination unit 203 according to the comparison example.

### DETAILED DESCRIPTION OF THE PREFERRED EMBODIMENTS

According to one aspect of the present invention, there is provided a signal recognizing device which is mounted on a moving body and which electromagnetically connects to a camera, comprising: a signal display candidate detecting unit which detects a green lamp candidate area from an image obtained from the camera; a reference calculating unit which calculates a time-series statistic of unit area values per unit area of the green lamp candidate area in a state where a red lamp is lit, and which stores the statistics on a storage unit; and a green lighting determination unit which determines whether or not a green lamp is lit based on the image including the green lamp candidate area in a state where the red lamp is unlit and the statistics, in case of determining that the red lamp varies from a lit state to an unlit state; wherein the reference calculating unit omits unit area values of unit areas of the green lamp candidate area from samples for calculating the statistics, provided that between the unit area values and either the statistics or unit area values of unit areas of a green lamp candidate area existing in a previously obtained image are larger than a predetermined threshold.

The above signal recognizing device is mounted on a moving body such as a vehicle, and electromagnetically connects to a camera by wire or wireless. The signal recognizing device includes a storage unit, a signal display candidate detecting unit, a reference calculating unit and a green lighting determination unit. The signal display candidate detecting unit detects a green lamp candidate area of the traffic signal from an image obtained from the camera. The term “green lamp candidate area” herein indicates an area used by the signal recognizing device as a display part of the green lamp in the image obtained from the camera. The reference calculating unit calculates time-series statistics of unit area values of unit areas to store the statistics in the storage unit. The term “unit area” herein indicates an area composed of a predetermined number of adjacent pixels and divided on the basis of a predetermined protocol. In other words, the unit area is an area which includes a predetermined number of adjacent pixels, and it may consist of one pixel or may be an area corresponding to the green lamp candidate area. The term “unit area value” herein indicates a value calculated based on statistical processing of the pixel values of each pixel existing in a unit area such as the average and the representative value. The term “pixel value” is an all-inclusive term of an index value which shows information each pixel has such as brightness, saturation and hue. The term “statistic” indicates a value obtained by statistical processing, and the statistical processing is an averaging processing for calculating the moving average, for example. At that time, the reference calculating unit calculates each difference between the unit area values in the green lamp candidate area and either the statistics stored in the storage unit or the unit area values of unit areas of the green lamp candidate area existing in a previously obtained image. Then, the reference calculating unit omits the unit area values from the samples for calculating the statistics when the above-mentioned each difference is larger than a predetermined threshold. In other words, as to the unit areas of the green lamp candidate area where the above-mentioned each difference is equal to or smaller than the threshold, the reference calculating unit updates the statistics by using the unit area values, and as to the unit areas in the green lamp candidate area where the above-mentioned each difference is larger than the threshold, it keeps using the statistics without updating them. Here, “the previously obtained image” may be the most recently obtained image or may be an image obtained before a predetermined duration. The green lighting determination unit determines whether or not a green lamp is lit based on the image including the red lamp candidate area at the time when the red lamp is unlit and the statistics stored in the storage unit, in case of determining that the red lamp varies from a lit state to an unlit state. Thereby, the signal recognizing device can precisely recognize the green lit state even when the obstruction or the red-green simultaneous lighting occurs.

In one mode of the signal recognizing device, the statistic is a moving average.

In another mode of the signal recognizing device, the reference calculating unit changes the threshold based on a state of the moving body and/or the image. The term “changes the threshold based on a state of the moving body” herein indicate dynamically changing the threshold based on the velocity and/or the acceleration of the moving body, for example. The term “changes the threshold based on the image” herein indicates dynamically setting the threshold based on the pixel values or the unit area values of the red lamp area or yellow lamp area in the obtained image. Thereby, the signal recognizing device can flexibly set the above-mentioned threshold based on the state of the moving body and others.

In another mode of the signal recognizing device, the signal display candidate detecting unit further detects a red lamp candidate area from the image; the unit area value is a value calculated based on brightness of each pixel existing in the unit area; and the threshold is set based on brightness of the red lamp candidate area. Generally, the brightness in the lit state of the red lamp almost coincides with the brightness in the lit state of the green lamp, and the brightness in the unlit state of the red lamp almost coincides with the brightness in the unlit state of the green lamp. Thus, by setting the threshold based on the brightness of the red lamp candidate area, the signal recognizing device can prevent the unit area value of the green lamp candidate area in the lit state from being included in the calculation of the statistic even when the red-green simultaneous lighting occurs.

In another mode of the signal recognizing device, the threshold is set to one half of the brightness of the red lamp candidate area in a state where the red lamp is lit. The term “the brightness of the red lamp candidate area” herein indicates an average or another representative value of the brightness of the pixels existing in the red lamp candidate area. In this mode, the signal recognizing device considers the brightness of the red lamp in the unlit state as 0, and sets the above-mentioned threshold to one half of the brightness of the red lamp candidate area in the lit state of the red lamp. In this way, by setting the above-mentioned threshold based on the brightness of the red lamp candidate area, the signal recognizing device can prevent the unit area value of the green lamp candidate area in the lit state from being included in the calculation of the statistic even when the red-green simultaneous lighting occurs.

In another mode of the signal recognizing device, the threshold is set to a larger value as a speed of the moving body is higher. In this mode, considering the fact that the time variation in the image obtained from the camera becomes great in a case where the velocity of the moving body is high, the signal recognizing device changes the threshold to a more permissive value in the case. In this way, the signal recognizing device can flexibly set the above-mentioned threshold according to the velocity of the moving body.

In another mode of the signal recognizing device, the reference calculating unit calculates the statistics by omitting a predetermined number of the images obtained just before it determines that the red lamp varies from a lit state to an unlit state, and the green lighting determination unit determines whether or not the green lamp is lit based on the statistics. In this mode, the signal recognizing device determines that the red-green simultaneous lighting is likely to be displayed in the predetermined number of the images obtained just before it determines that the red lamp varies from a lit state to an unlit state, and does not use them for calculating the statistics. Thereby, the signal recognizing device can properly calculate the statistics of the green lamp candidate area at the time of the unlit state of the green lamp even when the red-green simultaneous lighting is displayed in the image.

According to another aspect of the present invention, there is provided a signal recognizing method executed by a signal recognizing device which is mounted on a moving body and which electromagnetically connects to a camera, comprising: a signal display candidate detecting process which detects a green lamp candidate area from an image obtained from the camera; a reference calculating process which calculates a time-series statistic of unit area values per unit area of the green lamp candidate area in a state where a red lamp is lit, and which stores the statistics on a storage unit; and a green lighting determination process which determines whether or not a green lamp is lit based on the image including the green lamp candidate area in a state where the red lamp is unlit and the statistics, in case of determining that the red lamp varies from a lit state to an unlit state; wherein the reference calculating process omits unit area values of unit areas of the green lamp candidate area from samples for calculating the statistics, provided that between the unit area values and either the statistics or unit area values of unit areas of a green lamp candidate area existing in a previously obtained image are larger than a predetermined threshold. By executing the above-mentioned method, the signal recognizing device can precisely recognize the green lit state even when the obstruction or the red-green simultaneous lighting occurs.

According to still another aspect of the present invention, there is provided a signal recognizing program executed by a signal recognizing device which is mounted on a moving body and which electromagnetically connects to a camera, making the signal recognizing device function as: a signal display candidate detecting unit which detects a green lamp candidate area from an image obtained from the camera; a reference calculating unit which calculates a time-series statistic of unit area values per unit area of the green lamp candidate area in a state where a red lamp is lit, and which stores the statistics on a storage unit; and a green lighting determination unit which determines whether or not a green lamp is lit based on the image including the green lamp candidate area in a state where the red lamp is unlit and the statistics, in case of determining that the red lamp varies from a lit state to an unlit state; wherein the reference calculating unit omits unit area values of unit areas of the green lamp candidate area from samples for calculating the statistics, provided that between the unit area values and either the statistics or unit area values of unit areas of a green lamp candidate area existing in a previously obtained image are larger than a predetermined threshold. By the above program being installed and executed, the signal recognizing device can precisely recognize the green lit state even when the obstruction or the red-green simultaneous lighting occurs. In a preferred example, the above program is stored in a recording medium.

### Embodiment

Preferred embodiments of the present invention will be explained hereinafter with reference to the drawings. The term “pixel value” herein indicates an all-inclusive term of index values which indicates information that each pixel has, such as brightness, saturation and hue. The term “red lamp part” herein indicates apart emitting red light in a traffic signal and the term “green light part” herein indicates apart emitting green light in a traffic signal.

[Schematic Configuration]

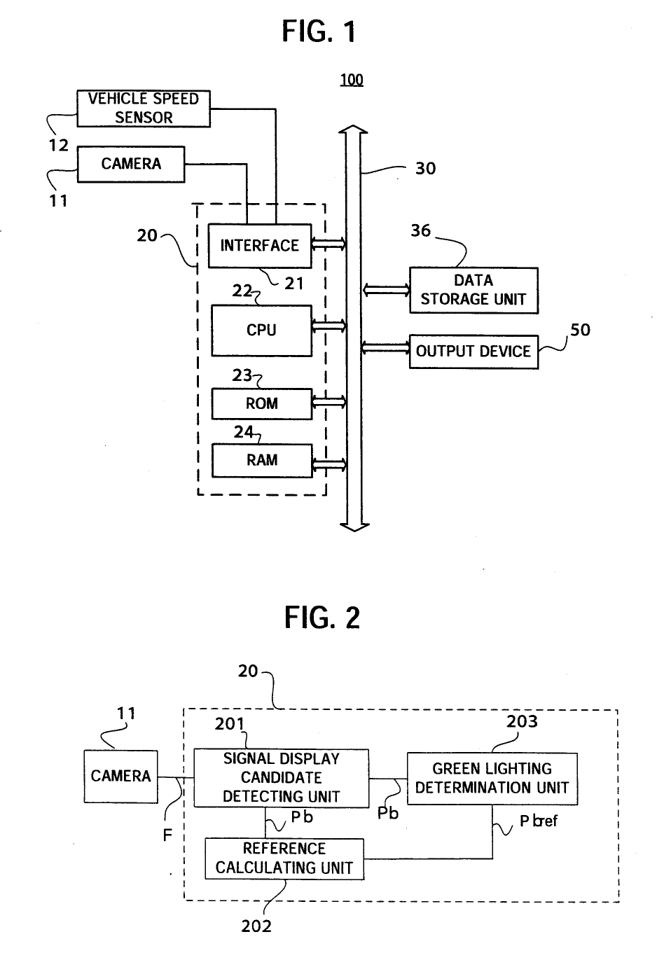

First, a description will be given of a configuration of the signal recognizing device 100 according to the embodiment. FIG. 1 shows an example of the schematic configuration of the signal recognizing device 100. The signal recognizing device 100 is mounted on a vehicle, and includes a camera 11, a vehicle speed sensor, a system controller 20, a data storage unit 36 and an output device 50.

The camera 11 has a predetermined angle of view, and is an optical instrument which captures an object in the angle of view. In the embodiment, the camera 11 is directed toward the front of the vehicle (hereinafter referred to as “equipped vehicle”) equipped with the signal recognizing device 100, and is provided on a position where the camera 11 can capture the traffic signal. The vehicle speed sensor 12 measures vehicle speed pulses including a pulse signal generated with the wheel rotation of the equipped vehicle.

The system controller 20 includes an interface 21, a CPU (Central Processing Unit) 22, a ROM (Read Only Memory) 23 and a RAM (Random Access Memory) 24, and controls the entire signal recognizing device 100. The system controller 20 corresponds to the signal display candidate detecting unit, the reference calculating unit, and the green lighting determination unit.

The interface 21 executes the interface operation with the camera 11 and the system controller 20. Then, the interface 21 is supplied with an image (hereinafter referred to as “image F”) by the camera 11 at predetermined time intervals, and it inputs the image F into the system controller 20. The interface 21 is supplied with the vehicle speed pulses from the vehicle speed sensor 12, and it inputs the vehicle speed pulses into the system controller 20.

The CPU 22 controls the entire system controller 20. By executing a program prepared in advance, the CPU 22 executes the signal recognition process described below. The ROM 23 includes a non-volatile memory, not shown, in which a control program for controlling the system controller 20 is stored. The RAM 24 readably stores various kinds of data, and supplies a working area to the CPU 22.

The system controller 20, the data storage unit 36 and the output device 50 are connected to each other via a bus line 30.

The data storage unit 36 includes HDD, for example, and stores various kinds of data. The output device 50 is a display or sound output device, for example, and outputs the signal recognition result recognized by the system controller 20.

[Control Method]

Next, the process executed by the system controller 20 will be described. Summarily, in a state (hereinafter referred to as “red lit state”) where the red lamp part is lit, the system controller 20 extracts a candidate area (hereinafter, referred to as “green light candidate area Lb”) of the green lamp from the image F, and it calculates the moving average per pixel whose samples are limited only to pixels which meets predetermined conditions. Then, if the system controller 20 detects a state (hereinafter referred to as “red unlit state”) where the red lamp part is unlit, the system controller 20 determines whether or not the green lamp part is lit based on the above-mentioned moving average and the green lamp candidate area Lb shown after the red lamp part is unlit. Thereby, the system controller 20 certainly recognizes the lighting of the green lamp part even when the traffic signal is temporarily obscured or when the simultaneous lighting of the red lamp part and the green lamp is shown in the image F due to the exposure time.

The concrete description thereof will be given with reference to FIG. 2. FIG. 2 is one example of a functional block of the signal recognizing device 100 according to the embodiment. As shown in FIG. 2, the system controller 20 includes a signal display candidate detecting unit 201, a reference calculating unit 202 and a green lighting determination unit 203.

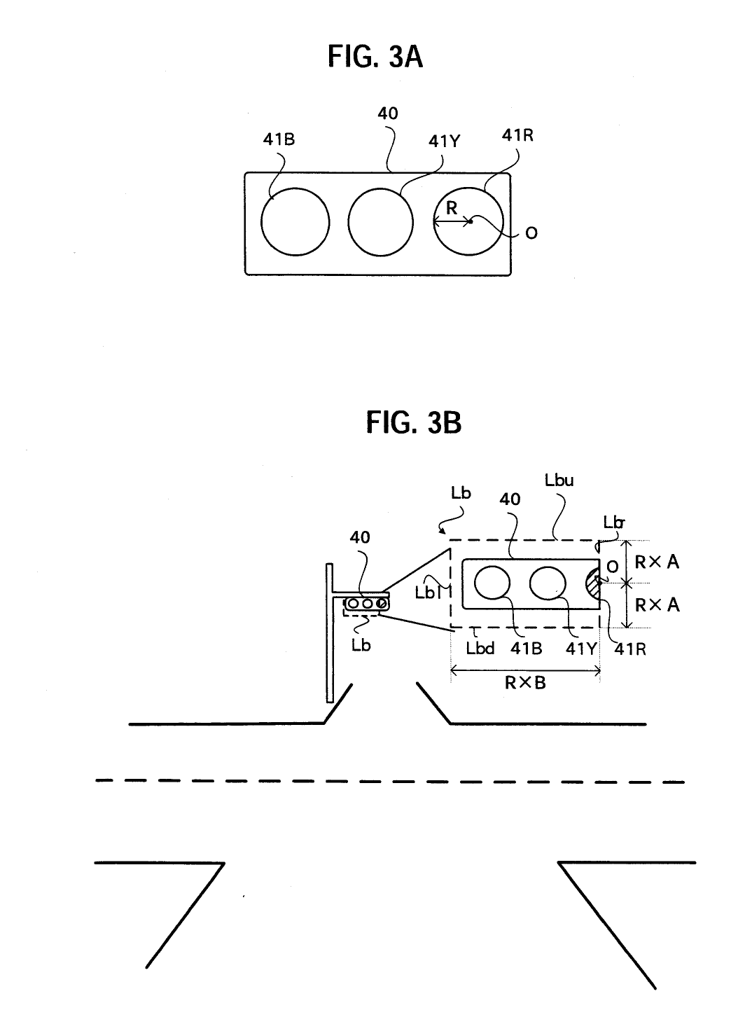

First, the process executed by the signal display candidate detecting unit 201 will be described. The signal display candidate detecting unit 201 extracts the red lamp candidate area Lr and the green lamp candidate area Lb from the image F. The concrete description thereof will be given with reference to FIG. 3.

FIG. 3A shows a traffic signal 40. From left to right, the traffic signal 40 includes a green lamp part 41B, a yellow lamp part 41Y and a red lamp part 41R. The symbol “◯” in the figure indicates the center of the red lamp part 41R, and the symbol “R” indicates the radius of the red lamp part 41R.

First, the signal display candidate detecting unit 201 identifies the red lamp candidate area Lr from the image F. For example, when the vehicle speed of the equipped vehicle is 0, the signal display candidate detecting unit 201 calculates the brightness, the saturation and the hue of each pixel in the image F. Then, the signal display candidate detecting unit 201 extracts the pixels existing in the range of the possible values of the brightness, the saturation and the hue at the time when the red lamp part 41R is lit. It is noted that the signal display candidate detecting unit 201 stores the range of the possible values of the brightness, the saturation and the hue at the time when the red lamp part 41R is lit in the memory such as the data storage unit 36 in advance. The signal display candidate detecting unit 201 calculates the degree of circularity of the areas composed of the extracted pixels, and recognizes the area which has the highest degree of circularity as the red lamp candidate area Lr. The calculation method of the above-mentioned degree of circularity is explained in detail in Japanese Patent Application Laid-open under No. 2005-301519.

Next, the signal display candidate detecting unit 201 recognizes the green lamp candidate area Lb based on the position and the scale of the red lamp candidate area Lr. The concrete example thereof will be described below. Based on the red lamp candidate area Lr, the signal display candidate detecting unit 201 recognizes the position of the center ◯ and the radius R in the red lamp part 41R shown in FIG. 3A. Then, the signal display candidate detecting unit 201 extracts the green lamp candidate area Lb based on the position of the center ◯ and the radius R. Concretely, as also shown in FIG. 3B to be described below, given that “A” and “B” are predetermined values for example, the signal display candidate detecting unit 201 sets the horizontal lines passing the positions which are vertically spaced from the center ◯ by “R×A” in the image F as the upper border line “Lbu” and the lower border line “Lbd” of the green lamp candidate area Lb. The signal display candidate detecting unit 201 sets the vertical line passing the center ◯ as the right border line “Lbr” of the green lamp candidate area Lb, and it sets the vertical line passing the positions which are spaced from the center ◯ by “R×B” in the left direction as the left border line “Lbl”.

FIG. 3B shows an image including the traffic signal 40 and an enlarged view of the green lamp candidate area Lb in the image. As shown in FIG. 3B, the green lamp candidate area Lb is set so that the green lamp candidate area Lb includes the green lamp part 41B. In this way, the signal display candidate detecting unit 201 stores the numbers A and B set by experimental trials in its memory thereby to set the green lamp candidate area Lb including the green lamp part 41B. Then, the signal display candidate detecting unit 201 supplies the reference calculating unit 202 with each pixel value (hereinafter referred to as “green candidate area pixel value Pb”) of the green lamp candidate area Lb.

Hereinafter, as one example, it is assumed that the signal display candidate detecting unit 201 recognizes the red lamp candidate area Lr and the green lamp candidate area Lb when the equipped vehicle is at a stop. It is also assumed that the signal display candidate detecting unit 201 keeps the positions, the scales and the ranges of the red lamp candidate area Lr and the green lamp candidate area Lb unchanged in the image F when the equipped vehicle is at a stop, and that the system controller 20 stops the traffic signal recognition process when the equipped vehicle is running.

The signal display candidate detecting unit 201 detects the red unlit state based on the red lamp candidate area Lr. For example, the signal display candidate detecting unit 201 determines that the red lamp part 41R is unlit in a case where the red lamp candidate area Lr becomes unable to be detected or a case where the brightness of each pixel in the red lamp candidate area Lr varies by equal to or larger than predetermined value. In this case, the signal display candidate detecting unit 201 supplies the green lighting determination unit 203 with the green candidate area pixel value Pb in the unlit state of the red lamp part 41R.

Next, a description will be given of the process executed by the reference calculating unit 202. The reference calculating unit 202 calculates the moving averages of the pixels in the green lamp candidate area Lb while the traffic signal is in the red lit state. Concretely, until detecting the red unlit state, the reference calculating unit 202 calculates the moving average (hereinafter referred to as “moving average Pbref”) of the green candidate area pixel values Pb per pixel every time the green candidate area pixel value Pb is supplied, and stores the moving average Pbref in the ROM 23 or the data storage unit 36 (hereinafter simply referred to as “memory”). Here, the number of samples used for the purpose of calculating the moving average Pbref is set in advance to a value in consideration of the disturbance, for example. For example, the number of the samples may be set so that the samples include all the green candidate area pixel values Pb obtained by the reference calculating unit 202 in the red lit state. In this way, the reference calculating unit 202 calculates the moving average Pbref which is insusceptible to the disturbance as the representative pixel value of the green lamp part 41B in the unlit state. Thereby, it is possible to improve the accuracy of the traffic signal recognition executed by the green lighting determination unit 203.

Every time the image F is supplied from the camera 11, the reference calculating unit 202 calculates the difference (hereinafter referred to as “first difference Dif1”) between the green candidate area pixel value Pb in the image F and the moving average Pbref stored in the memory with respect to each corresponding pixel. Then, the reference calculating unit 202 omits the green candidate area pixel values Pb where each first difference Dif1 thereof is larger than a predetermined threshold (hereinafter referred to as “threshold T1”) from the samples for calculating the moving average Pbref. In other words, in this case, without recalculating the moving average Pbref for the above-mentioned pixels, the reference calculating unit 202 keeps the moving average Pbref which was used for calculating the first difference Dif1 stored. The threshold T1 is set by experimental trials to a value which is resistant to the influence caused by the obstruction and the red-green simultaneous lighting. Thereby, the reference calculating unit 202 can precisely calculate the moving average Pbref even if the obstruction and/or the red-green simultaneous lighting described below occur.

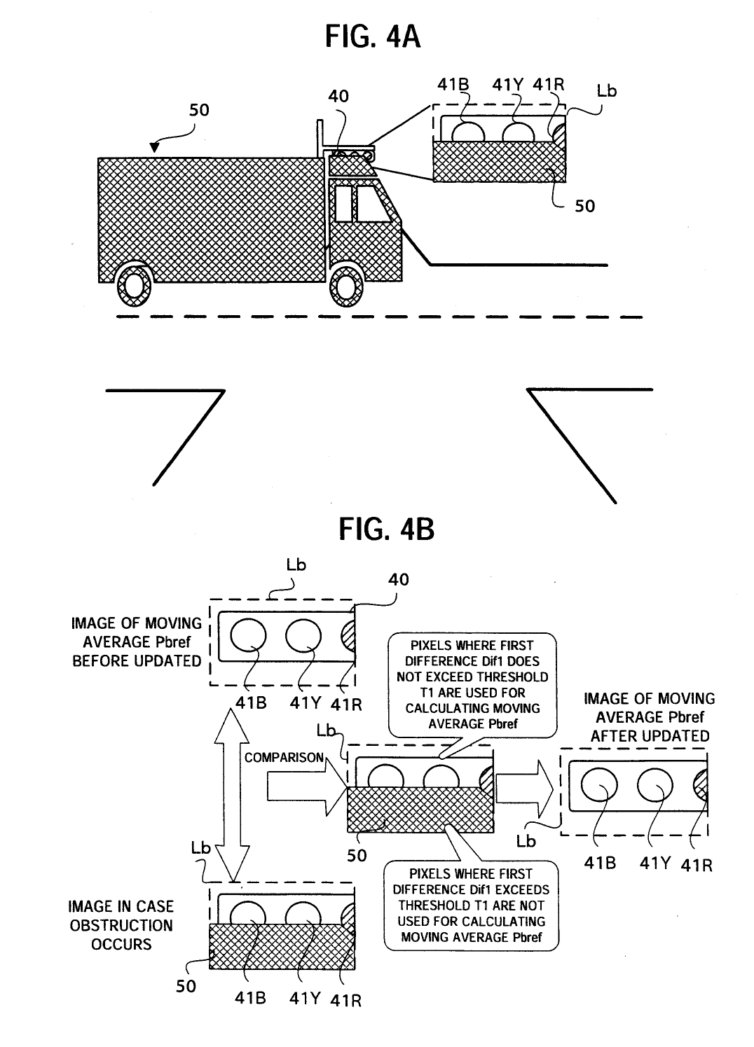

The description thereof will be given with reference to FIGS. 4A and 4B. FIG. 4A shows the image F in a case where the obstruction occurs and the enlarged view of the green lamp candidate area Lb thereof. In FIG. 4A, a part of the traffic signal 40 is obscured by the vehicle 50. Thereby, a part of the vehicle 50 is shown in the green lamp candidate area Lb. Even in this case, by setting the threshold T1, the reference calculating unit 202 can calculate the moving average Pbref without the influence caused by the obstruction by the vehicle 50. The description thereof will be given with reference to FIG. 4B.

FIG. 4B schematically shows the process executed by the reference calculating unit 202 according to the embodiment. As shown in FIG. 4B, the reference calculating unit 202 compares each pixel of “IMAGE IN CASE OBSTRUCTION OCCURS”, i.e., the image F which is supplied from the camera 11 and which shows the green lamp candidate area Lb at the occurrence time of the obstruction, to each pixel of “IMAGE OF MOVING AVERAGE Pbref BEFORE UPDATED”, i.e., an image composed of the moving averages Pbref. Then, with respect to pixels where each first difference Dif1 thereof is equal to or smaller than the threshold T1, i.e., pixels without obstruction of the vehicle 50, the reference calculating unit 202 recalculates the moving averages Pbref by using the pixel values thereof. In contrast, with respect to pixels where each first difference Dif1 thereof is larger than the threshold T1, i.e., pixels obstructed by the vehicle 50, the reference calculating unit 202 keeps using the previous moving average Pbref without recalculating the moving average Pbref. The image composed of the moving averages Pbref updated by the process thereof is “IMAGE OF MOVING AVERAGE Pbref AFTER UPDATED” shown in FIG. 4B. In this way, even in the case where the obstruction by the vehicle 50 occurs, the reference calculating unit 202 can calculate the moving average Pbref by eliminating the influence thereof.

Next, the description will be given of the process executed by the green lighting determination unit 203 with reference to FIG. 2 again. When the signal display candidate detecting unit 201 detects the red unlit state, the green lighting determination unit 203 determines whether or not the green lamp part 41B is lit based on both the green candidate area pixel value Pb in the image F obtained at the time of the detection or just after the detection and the moving average Pbref stored in the memory.

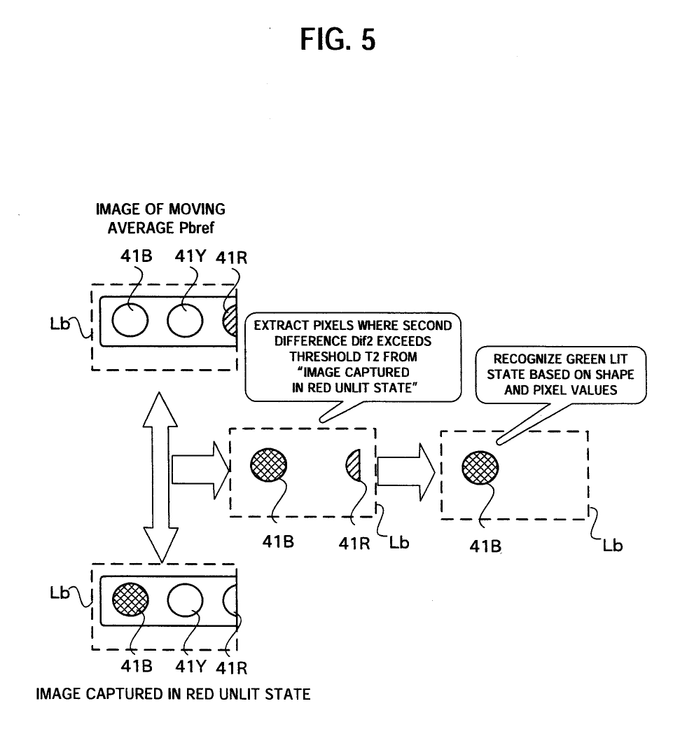

The description thereof will be given with reference FIG. 5. FIG. 5 schematically shows the process executed by the green lighting determination unit 203. First, as shown in FIG. 5, the green lighting determination unit 203 calculates the difference (herein after referred to as “second difference Dif2”) between the moving average Pbref stored in the memory and the green candidate area pixel value Pb in the image F obtained at the time of red unlit state. Then, the green lighting determination unit 203 extracts the pixels where each second difference Dif2 thereof is larger than a predetermined threshold (hereinafter referred to as “threshold T2”) from the image F captured in the red unlit state. For example, the threshold T2 is set to one half of the difference between the estimated pixel value at the time of the lit state of the green lamp part 41B and the estimated pixel value at the time of the unlit state of the green lamp part 41B, and it is stored in the memory.

Then, based on the shape and a pixel value or pixel values such as hue and brightness, the green lighting determination unit 203 determines whether or not the area (extracted area) composed of the extracted pixels shows the green lamp part 41B at the time of the lit state. The concrete example thereof will be described below. For example, the green lighting determination unit 203 determines whether or not each pixel in the extracted area has a value in the range of the possible values of the hue, saturation, brightness in the green lamp part 41B at the time of the lit state. It is noted that the green lighting determination unit 203 stores the information of the range of the possible values of the hue, saturation, brightness in the green lamp part 41B at the time of the lit state in its memory in advance. The green lighting determination unit 203 also calculates the degree of circularity of the extracted area to determine whether or not the extracted area shows the green lamp part 41B. The detail of the calculation method of the degree of the circularity will not be described since the detailed explanation has already been given in “Japanese Patent Application Laid-open under No. 2005-301519”.

[Process Flow]

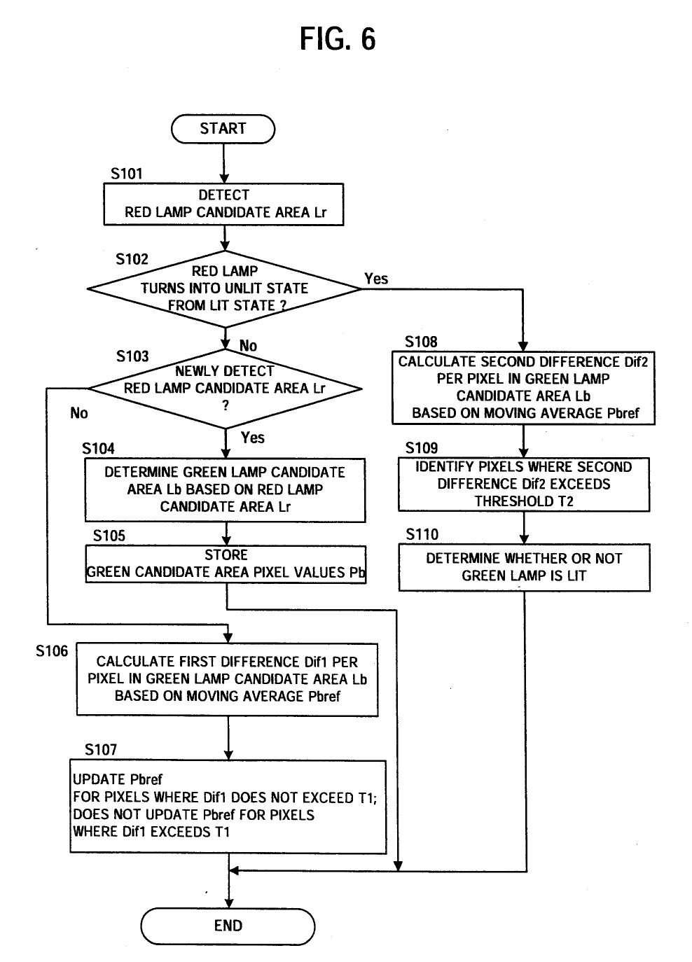

Next, the description will be given of a procedure of the process according to the embodiment. FIG. 6 is one example showing the procedure of the process executed by the system controller 20 according to the embodiment. The system controller 20 repeatedly executes the process of the flowchart shown in FIG. 6 every time the system controller 20 obtains the image F from the camera 11.

First, the system controller 20 detects the red lamp candidate area Lr in the image F (step S101). When the system controller 20 does not detect the red lamp candidate area Lr, the system controller 20 keeps trying to detect the red lamp candidate area Lr.

Next, the system controller 20 determines whether or not the red lamp part 41R turns into the red unlit state from the red lit state (step S102). When the red lamp part 41R turns into the red unlit state from the red lit state (step S102; Yes), the system controller 20 executes the process at step S108 to S110. The description thereof will be given below.

In contrast, when the red lamp part 41R does not turn into the red unlit state from the red lit state (step S102; No), the system controller 20 determines whether or not the system controller 20 newly detected the red lamp candidate area Lr (step S103). Namely, the system controller 20 determines whether or not it has not yet identified the green lamp candidate area Lb corresponding to the detected red lamp candidate area Lr. In a case where the system controller 20 newly detected the red lamp candidate area Lr (step S103; Yes), the system controller 20 determines the green lamp candidate area Lb based on the red lamp candidate area Lr (step S104). Concretely, as illustrated in the context of FIG. 3A, the system controller 20 recognizes the center ◯ and the radius R and identifies the green lamp candidate area Lb thereby. Then, the system controller 20 stores the green candidate area pixel values Pb in its memory (step S105). Thereafter, the system controller 20 uses the green candidate area pixel values Pb as the initial values of the moving average Pbref at the next time the system controller 20 obtains the image F and executes the process of the flowchart.

In contrast, when the system controller 20 does not newly detect the red lamp candidate area Lr (step S103; No), i.e., it has already detected the red lamp candidate area Lr, the system controller 20 calculates the first difference Dif1 per pixel in the green lamp candidate area Lb based on the moving average Pbref (step S106). Concretely, per pixel in the green lamp candidate area Lb, the system controller 20 calculates the difference between the moving average Pbref stored in the memory and the green candidate area pixel value Pb in the image F obtained at the start time of the flowchart as the first difference Dif1.

Next, for the pixels where each first difference Dif1 thereof is equal to or smaller than the threshold T1, the system controller 20 updates the moving average Pbref, and for the pixels where each first difference Dif1 thereof is larger than the threshold T1, the system controller 20 keeps using the past moving average Pbref (step S107). In other words, with respect to the pixels each first difference Dif1 of which is equal to or smaller than the threshold T1, the system controller 20 recalculates the moving average Pbref by adding the green candidate area pixel value Pb in the image F obtained at the start time of the flowchart. In contrast, with respect to the pixels each first difference Dif1 of which is larger than the threshold T1, the system controller 20 does not use the green candidate area pixel value Pb for calculating the moving average Pbref. Thereby, even in the case where the traffic signal 40 is obstructed and/or the red-green simultaneous lighting occurs in the image F, the system controller 20 can calculate the moving average Pbref without the influence thereof.

In contrast, at step S102, when the system controller 20 determines that the traffic signal 40 turns into the red lit state to the red unlit state (step S102; Yes), the system controller 20 calculates the second difference Dif2 per pixel in the green lamp candidate area Lb on the basis of the moving average Pbref (step S108). Concretely, the system controller 20 calculates the difference between the moving average Pbref stored in the memory and the green candidate area pixel value Pb in the image F obtained at the start time of the flowchart and sets it to the second difference Dif2.

Next, the system controller 20 identifies the pixels where each second difference Dif2 thereof is larger than the threshold T2 (step S109). Based thereon, the system controller 20 makes the determination of the green lit state (step S110). Concretely, based on the shape formed by the extracted pixels and the pixel value (s) thereof such as hue and brightness, the system controller 20 determines whether or not the green lamp part 41B is lit.

As described above, the above signal recognizing device is mounted on a vehicle, and includes a camera, a storage unit, a signal display candidate detecting unit, a reference calculating unit and a green lighting determination unit. The signal display candidate detecting unit detects a red lamp candidate area and a green lamp candidate area of the traffic signal from an image obtained from the camera. The reference calculating unit calculates a moving average of a pixel value of each pixel existing in the green lamp candidate area, and stores the moving averages in the storage unit. At that time, the reference calculating unit omits unit area values of the green lamp candidate area from the samples for calculating the moving averages, provided that between the pixel values and the moving averages stored in the storage unit are larger than a predetermined threshold. In other words, for the unit areas having the above-mentioned each difference equal to or smaller than the threshold, the reference calculating unit updates the moving averages by using the unit area values thereof, and for the unit areas having the above-mentioned each difference larger than the threshold, it keeps using the moving averages thereof without updating them. In case of determining that the red lamp turns into the unlit state from the lit state, the green lighting determination unit determines whether or not a green lamp is lit on the basis of the image captured at the time of the unlit state of the red lamp and the moving averages stored in the storage unit. Thereby, the signal recognizing device can precisely recognize the green lit state even when the obstruction or the red-green simultaneous lighting occurs.

[Modification]

Each modification of the embodiment will be described below. Each modification can be applied to the above-mentioned embodiment in combination.

(First Modification)

In the explanation with respect to FIG. 1, the signal recognizing device 100 includes the camera 11. The configuration to which the present invention can be applied, however, is not limited to the configuration. Instead of the above-mentioned configuration, the signal recognizing device 100 and the camera 11 may be separate devices from each other. In this case, for example, the signal recognizing device 100 is electromagnetically connected to the camera 11 by wired or wireless connection, and is supplied with the image F from the camera 11 at predetermined intervals.

(Second Modification)

In the explanation with respect to FIG. 3, the traffic signal 40 has the format (hereinafter referred to as “horizontally-lined traffic signal format”) in which the green lamp part 41B, the yellow lamp part 41Y and the red lamp part 41R are lined horizontally to the ground. In addition to this format, the present invention can also be applied to a format (hereinafter referred to as “vertically-lined traffic signal format”) in which each display unit is lined vertically to the ground.

In case of the vertically-lined traffic signal format, the signal display candidate detecting unit 201 sets the vertical lines passing the positions spaced from the center ◯ in the right/left direction by “R×A” in the image F to the left border line Lbl and the right border line Lbr, for example. The signal display candidate detecting unit 201 also sets the horizontal lines passing the center ◯ to the upper border line Lbu of the green lamp candidate area Lb, and sets the horizontal lines passing the positions spaced from the center ◯ in the downward by “R×B” to the lower border line Lbd.

Even in case of the vertically-lined traffic signal format, by determining the green lamp candidate area Lb as described above, the signal recognizing device 100 can calculate the moving averages Pbref based on the green lamp candidate area Lb to recognize the green lit state similarly to the above-mentioned embodiment.

(Third Modification)

In the explanation of the reference calculating unit 202 in FIG. 2, the moving average Pbref is calculated based on the one kind of the pixel value. A method to which the present invention can be applied, however, is not limited to the method. Instead of the above-mentioned method, the reference calculating unit 202 may calculate the moving average Pbref based on at least two kinds of the pixel value.

Here, the concrete example will be given in a case where brightness and hue are used as the pixel values in the embodiment. In this case, the reference calculating unit 202 stores thresholds T1 each suited to the brightness and the hue in advance. Hereinafter, the threshold T1 for the brightness is especially referred to as “threshold T1L”, and the threshold T1 for the hue is especially referred to as “threshold T1C”. Then, the reference calculating unit 202 calculates each first difference Dif1 with respect to the brightness and the hue, respectively. Hereinafter, the first difference Dif1 for the brightness is especially referred to as “first difference Dif1L”, and the first difference Dif1 for the hue is especially referred to as “first difference Dif1C”. Next, for pixels where each first difference Dif1L thereof does not exceed the threshold T1L and where each first difference Dif1C thereof does not exceed the threshold TIC, the reference calculating unit 202 updates each moving average Pbref of the brightness and the hue. In contrast, for the other pixels, the reference calculating unit 202 does not update each moving average Pbref for the brightness and the hue. In another example, for pixels where each first difference Dif1L thereof does not exceed the threshold T1L or pixels where each first difference Dif1C thereof does not exceed the threshold T1C, the reference calculating unit 202 updates each moving average Pbref for the brightness and the hue, and for the other pixels, the reference calculating unit 202 does not updates each moving average Pbref.

In the above-mentioned cases, the green lighting determination unit 203 stores the thresholds T2 each suited to the brightness and the hue in advance. Then, the green lighting determination unit 203 calculates each second difference Dif2 based on each moving average Pbref for the brightness and the hue. Next, for example, the green lighting determination unit 203 identifies pixels where each second difference Dif2 thereof for the brightness and the hue is larger than the threshold T2, respectively.

As described above, even in case of calculating the moving averages Pbref of multiple kinds of pixel values, the system controller 20 can calculate the moving averages Pbref without influence caused by the obstruction of the traffic signal 40 or the red-green simultaneous lighting in the image F.

[Fourth Modification]

In addition to the process according to the embodiment, the system controller 20 may store default values of the moving averages Pbref in its memory in advance. In this case, each default value is set by experimental trials to a typical value of the green candidate area pixel value Pb. In addition, in this case, the system controller 20 may consider that the green lamp part 41B is not included in the green lamp candidate area Lb if the moving averages Pbref of all the pixels have never been updated from the default values in a predetermined time period after the recognition of the green lamp candidate area Lb. Namely, in this case, the system controller 20 considers that it misidentifies the object other than a traffic signal as the traffic signal. In addition, the system controller 20 may also consider that it misidentifies the traffic signal if the number of pixels where each moving average Pbref thereof has ever been updated from the default value is at most a predetermined number.

(Fifth Modification)

According to the embodiment, at the time of calculating the moving averages Pbref, the reference calculating unit 202 does not use the green candidate area pixel values Pb where each first difference Dif1 is larger than the threshold T1. In addition to this, regardless of the first difference Dif1, the reference calculating unit 202 may not use pixels each of which does not belong to a predetermined range of the brightness and/or a predetermined range of the hue in the green lamp candidate area Lb at the time of calculating the moving average Pbref. The above-mentioned ranges are set by experimental trials to possible ranges of the brightness and the hue of the green lamp part 41B at the unlit state. Thereby, the reference calculating unit 202 can more precisely calculate the moving averages Pbref which is representative values of the green lamp part 41B at the unlit state.

(Sixth Modification)

A concrete description will be given of the process of setting the threshold T1 in case of using the brightness as the pixel value. Here, a description will be given of the process of setting the threshold T1 in such a way that the moving average Pbref can be precisely calculated even in the case where the red-green simultaneous lighting is shown in the image F.

In this case, the threshold T1 is set on the basis of the brightness of the red lamp part 41R. Concretely, given that the symbol “RLt” stands for brightness of the red lamp part 41R at the lit state and the symbol “RLs” stands for brightness of the red lamp part 41R at the unlit state, the threshold T1 is determined according to the following equation (1).

T1=(RLt−RLs)/2 (1)

Additionally, assuming the brightness RLs of the red lamp part 41R at the unlit state is “0”, the threshold T1 is determined according to the equation (2).

T1=RLt/2 (2)

Here, for example, an estimate value of the brightness RLs according to the equation (1) is determined by experimental trials in advance, and stored in the memory. In addition, the system controller 20 may determine the brightness RLt based on brightness of pixels in the red lamp candidate area Lr. Concretely, the system controller 20 may set a representative brightness of the area such as the average brightness of the area to the brightness RLt. In this case, the threshold T1 is a variable value which varies depending on each target traffic signal 40 or each target image F.

A supplemental explanation will be given of the effect according to the sixth modification. Generally, brightness of the red lamp part 41R at a lit/unlit state is estimated to be almost identical to brightness of the green lamp part 41B at a lit/unlit state, respectively. Thus, by determining the threshold T1 based on the brightness RLt and RLs, the system controller 20 can omit pixels in the green lamp candidate area Lb at the lit state from the samples for calculating the moving average Pbref even in the case where the red-green simultaneous lighting is shown in the image F. In other words, the reference calculating unit 202 can more precisely calculate the moving average Pbref which is a representative pixel value of the green lamp part 41B at the unlit state.

(Seventh Modification)

A description will be given of an actual process of setting the threshold T2 in case of using brightness as the pixel value. In this case, the system controller 20 may determine the threshold T2 based on the brightness RLt of the red lamp part 41R at the lit state.

The concrete description thereof will be given below. The system controller 20 determines the threshold T2 based on the following equation (3).

T2=(RLt−RLs)/2 (3)

Here, the system controller 20 determines the brightness RLt based on the brightness of each pixel in the red lamp candidate area Lr. Actually, the system controller 20 sets a representative value of the brightness in the area such as the average to the brightness RLt. The system controller 20 stores an estimate value of the brightness RLs in its memory in advance.

As described above, by dynamically determining the threshold T2 based on the brightness RLt of the red lamp part 41R at the lit state, the system controller 20 can properly set the threshold T2.

(Eighth Modification)

The reference calculating unit 202 omits pixels where each first difference Dif1 thereof is larger than the threshold T1 from the calculation of the moving average Pbref. In addition, on detecting the red unlit sate, the reference calculating unit 202 may omit the green candidate area pixel values Pb in a predetermined number of images F obtained just before becoming the red unlit state from the samples for calculating the moving average Pbref. The above-mentioned predetermined number is set to an estimate value of the number of the image where the red-green simultaneous lighting could occur.

In this case, the reference calculating unit 202 stores not only the moving averages Pbref according to the embodiment in its memory but also the moving averages Pbref calculated before the acquisition of the predetermined number of image F. When the red lamp turns into the unlit state from the lit state, the green lighting determination unit 203 executes various kinds of process according to the embodiment by using the latter moving average Pbref.

Thereby, the reference calculating unit 202 can omit the pixels in the green lamp candidate area Lb at the lit state from the samples for calculating the moving average Pbref even in the case where the red-green simultaneous lighting is shown in the image F. In other words, the reference calculating unit 202 can more precisely calculate the moving average Pbref which is a representative pixel value of the green lamp part 41B at the unlit state.

(Ninth Modification)

The reference calculating unit 202 may change the threshold T1 based on the vehicle speed of the equipped vehicle. For example, the higher the vehicle speed is, the more the reference calculating unit 202 increases the threshold T1 assuming that the variation of the traffic signal 40 in the image F becomes greater. Namely, when the vehicle speed is high, the reference calculating unit 202 considers that the variation of the traffic signal 40 in the image F is great, and changes the threshold T1 to a more permissive value. In this case, the reference calculating unit 202 stores a map or an equation which associates each vehicle speed with the compatible threshold T1 in its memory, and the sets the threshold T1 based on the vehicle speed with reference to the above-mentioned map or the equation. Thereby, the signal recognizing device 100 can set the threshold T1 according to the state of the equipped vehicle even if the equipped vehicle is moving.

(Tenth Modification)

In the explanation of FIG. 2, after determining the red lamp candidate area Lr and the green lamp candidate area Lb, the system controller 20 fixes positions, ranges and scales thereof. A method to which the present invention can be applied, however, is not limited to the method. Instead of this, the system controller 20 may determine the red lamp candidate area Lr and the green lamp candidate area Lb every time it obtains the image F.

Even in this case, the system controller 20 does not minify the range of the green lamp candidate area Lb. In other words, the system controller 20 determines the green lamp candidate area Lb so that the green lamp candidate area Lb includes the past green lamp candidate area Lb determined after the detection of the red lit state.

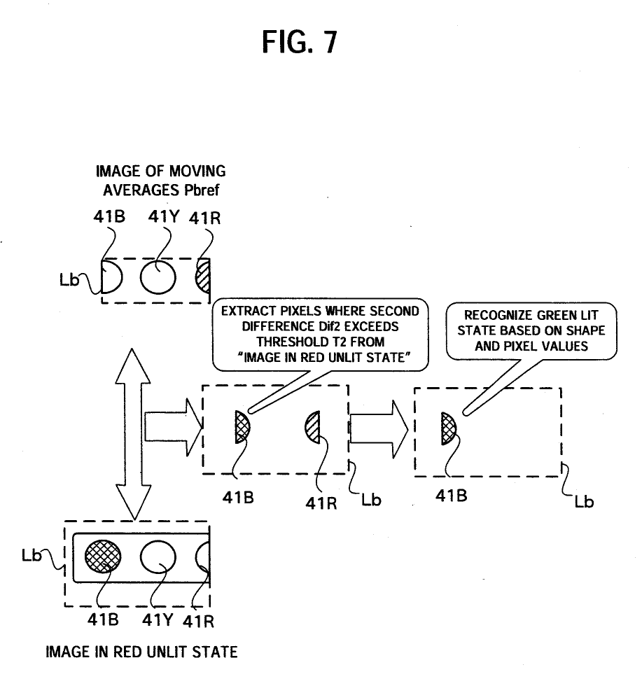

The description thereof will be given with reference to FIG. 7. FIG. 7 schematically shows the process executed by the green lighting determination unit 203. It is noted that FIG. 7 shows a case (hereinafter referred to as “comparison example”) where the signal display candidate detecting unit 201 accordingly minifies the range of the green lamp candidate area Lb according to the red lamp candidate area Lr instead of the embodiment. Additionally, the moving average Pbref is calculated per pixel in the common green lamp candidate area Lb thereof at the red lit state.

In this case, the signal display candidate detecting unit 201 detects nothing more than a part of the red lamp part 41R as the red lamp candidate area Lr. As a result, the target area of the moving averages Pbref does not include the whole area of the green lamp part 41B. Thus, in this case, since the green lighting determination unit 203 can detect only the part of the green lamp part 41B, it is possible that the green lit state cannot be properly recognized.

In consideration of the above-mentioned fact, without minifying the range of the green lamp candidate area Lb, the system controller 20 determines a new green lamp candidate area Lb so that the new green lamp candidate area Lb includes the past green lamp candidate area Lb in order to calculate the moving average Pbref with respect to whole range of the green lamp candidate area Lb. Thereby, the system controller 20 can more improve the recognition accuracy of the green lit state.

(Eleventh Modification)

In the embodiment, the reference calculating unit 202 calculates the moving average Pbref of the time-series candidate area pixel values Pb. A method to which the present invention can be applied, however, is not limited to the method. Instead of this, the reference calculating unit 202 may use a value (hereinafter referred to as “statistic”) obtained by statistical processing of the time-series green candidate area pixel values Pb other than the moving average Pbref. In this case, for example, according to a predetermined protocol, the reference calculating unit 202 executes the averaging procedure based on all or a part of the green candidate area pixel values Pb obtained in the past thereby to calculate the statistic.

(Twelfth Modification)

In the explanation of the embodiment, the reference calculating unit 202 calculates the moving average Pbref per green candidate area pixel value Pb, i.e., the pixel value of each pixel in the green lamp candidate area Lb, and based on the threshold T1, it determines whether or not it should use the green candidate area pixel value Pb as the samples for calculating the moving average Pbref. A method to which the present invention can be applied, however, is not limited to the method. Instead of this, the reference calculating unit 202 may calculate the green candidate area pixel value Pb per unit area (hereinafter simply referred to as “unit area”) which has a number of adjacent pixels to each other and which is determined on the basis of a predetermined protocol, and determine whether or not it should use the unit area for calculating the moving average Pbref on the basis of the threshold T1. In this case, the reference calculating unit 202 calculates a representative value (hereinafter referred to as “unit area value”) of each pixel in the unit area such as the average of the pixel values thereof, and it calculates the moving average Pbref based on the unit area value.

Thus, according to the twelfth modification, for example, when the unit area is set to the green lamp candidate area Lb, the reference calculating unit 202 calculates a moving average Pbref per green lamp candidate area Lb in order to determine whether or not the unit area should be used for calculating the moving average Pbref.

In case of the twelfth modification, the green lighting determination unit 203 calculates the second difference Dif2 per unit area, for example. Namely, in this case, the green lighting determination unit 203 calculates a unit area value of each unit area of the green lamp candidate area Lb in the image F at the red unlit state, and it calculates the second difference Dif2 per unit area by comparing the unit area value to the moving average Pbref calculated per unit area. In another example, the green lighting determination unit 203 calculates the second difference Dif2 per pixel by comparing a pixel value of each pixel in the green lamp candidate area Lb in the image F at the red unlit state to the moving average Pbref of the unit area corresponding to the pixel.

(Thirteenth Modification)

In the explanation of the embodiment, every time the image F is supplied from the camera 11, the reference calculating unit 202 calculates each first difference Dif1 i.e., a difference between each green candidate area pixel value Pb in the image F and the moving average Pbref. A method to which the present invention can be applied, however, is not limited to the method.

instead of this, or in addition to this, every time the image F is supplied from the camera 11, the reference calculating unit 202 may calculate each difference between each green candidate area pixel value Pb in the image F and the corresponding green candidate area pixel value Pb in the image F (hereinafter referred to as “past obtained image Fd”) obtained in the past as the first difference Dif1. The past obtained image Fd may be the image F obtained at the last minute or may be the image F obtained before a predetermined time. Even in this case, the reference calculating unit 202 omits a green candidate area pixel value Pb of a pixel where a first difference Diff calculated by use of the past obtained image Fd is larger than the threshold T1 from the samples for calculating the above-mentioned moving average Pbref. Even in this way, the reference calculating unit 202 can precisely calculate the moving average Pbref even in the case where the obstruction or the red-green simultaneous lighting occurs.

### INDUSTRIAL APPLICABILITY

This invention can be applied to a multipurpose device mounted on a vehicle, a navigation device and other kinds of devices which recognizes a traffic signal and which is mounted on a moving body. The term “multipurpose device” herein indicates a machine or a device which autonomously communicates with users and captures the scenery in the outside of the vehicle. The multipurpose device may also have a function to cooperate with a navigation device and a function to reproduce contents such as music and images if necessary.

### BRIEF DESCRIPTION OF REFERENCE NUMBERS

11 Camera

12 Vehicle speed sensor

20 System controller

22 CPU

36 Data storage unit

40 Traffic signal

50 Output device

100 Signal recognizing device

201 Signal display candidate detecting unit

202 Reference calculating unit

203 Green lighting determination unit

1. A signal recognizing device which is mounted on a moving body and which electromagnetically connects to a camera, comprising:
a signal display candidate detecting unit which detects a green lamp candidate area from an image obtained from the camera;
a reference calculating unit which calculates a time-series statistic of unit area values per unit area of the green lamp candidate area in a state where a red lamp is lit, and which stores the statistics on a storage unit; and
a green lighting determination unit which determines whether or not a green lamp is lit based on the image including the green lamp candidate area in a state where the red lamp is unlit and the statistics, in case of determining that the red lamp varies from a lit state to an unlit state;
wherein the reference calculating unit omits unit area values of unit areas of the green lamp candidate area from samples for calculating the statistics, provided that each difference between the unit area values and either the statistics or unit area values of unit areas of a green lamp candidate area existing in an image previously obtained in an unlit state of the green lamp is larger than a predetermined threshold.

2. The signal recognizing device according to claim 1, wherein the statistic is a moving average.

3. The signal recognizing device according to claim 1,
wherein the reference calculating unit changes the threshold based on a running condition of the moving body and/or hue of a signal lamp area in the image.

4. The signal recognizing device according to claim 1,
wherein the signal display candidate detecting unit further detects a red lamp candidate area from the image;
wherein the unit area value is a value calculated based on brightness of each pixel existing in the unit area; and
wherein the threshold is set based on brightness of the red lamp candidate area.

5. The signal recognizing device according to claim 4,
wherein the threshold is set to one half of the brightness of the red lamp candidate area in a state where the red lamp is lit.

6. The signal recognizing device according to claim 3,
wherein the threshold is set to a larger value as a speed of the moving body is higher.

7. The signal recognizing device according to claim 1,
wherein the reference calculating unit calculates the statistics by omitting a predetermined number of the images obtained just before it determines that the red lamp varies from a lit state to an unlit state, and
wherein the green lighting determination unit determines whether or not the green lamp is lit based on the statistics.

8. A signal recognizing method executed by a signal recognizing device which is mounted on a moving body and which electromagnetically connects to a camera, comprising:
a signal display candidate detecting process which detects a green lamp candidate area from an image obtained from the camera;
a reference calculating process which calculates a time-series statistic of unit area values per unit area of the green lamp candidate area in a state where a red lamp is lit, and which stores the statistics on a storage unit; and
a green lighting determination process which determines whether or not a green lamp is lit based on the image including the green lamp candidate area in a state where the red lamp is unlit and the statistics, in case of determining that the red lamp varies from a lit state to an unlit state;
wherein the reference calculating process omits unit area values of unit areas of the green lamp candidate area from samples for calculating the statistics, provided that between the unit area values and either the statistics or unit area values of unit areas of a green lamp candidate area existing in an image previously obtained in an unlit state of the green lamp are larger than a predetermined threshold.

9. A signal recognizing program stored on a non-transitory storage medium and executed by a signal recognizing device which is mounted on a moving body and which electromagnetically connects to a camera, making the signal recognizing device function as:
a signal display candidate detecting unit which detects a green lamp candidate area from an image obtained from the camera;
a reference calculating unit which calculates a time-series statistic of unit area values per unit area of the green lamp candidate area in a state where a red lamp is lit, and which stores the statistics on a storage unit; and
a green lighting determination unit which determines whether or not a green lamp is lit based on the image including the green lamp candidate area in a state where the red lamp is unlit and the statistics, in case of determining that the red lamp varies from a lit state to an unlit state;
wherein the reference calculating unit omits unit area values of unit areas of the green lamp candidate area from samples for calculating the statistics, provided that between the unit area values and either the statistics or unit area values of unit areas of a green lamp candidate area existing in an image previously obtained in an unlit state of the green lamp are larger than a predetermined threshold.

10. (canceled)
